(19) United States
(12) Patent Application Publication
(10) Pub. No.: US 2011/0192003 A1
(43) Pub. Date: Aug. 11, 2011

(54) ARROWHEAD REMOVER AND METHOD OF USE THEREOF

(76) Inventor: Walter Nabity, Tolleson, AZ (US)

(21) Appl. No.: 12/703,349

(22) Filed: Feb. 10, 2010

(51) Int. Cl. B25B 27/02; B23P 19/04

(52) U.S. Cl. 29/426.1; 29/264

(57) ABSTRACT

An arrowhead removal device and a method of use thereof for removing an arrowhead comprising: a housing, wherein said housing includes openings that extend the length of the housing. A plurality of equally spaced slots is provided on the housing. The removal device further includes an attachment shaft, wherein said attachment shaft includes a threaded surface. The attachment shaft includes a first opening with a first diameter and a second opening with a second diameter where the second diameter is smaller than the first diameter, the first opening extending along a portion of the length of the shaft and abuts the second opening where the second opening extends further along the length of the shaft. The removal device also includes a means to move the shaft through the openings of the housing.

### BACKGROUND OF THE INVENTION

1. Field of Invention

The present invention relates to an arrowhead removal device that assists in removing an embedded arrowhead from an object.

2. Description of Related Art

Bow hunting is a popular sport wherein a hunter uses a bow and arrow as a means to kill their prey. Bow hunting provides a different experience than the hunting using a gun in that hunters must use additional skills such as stalking, waiting in a blind or tree stand and many times must attack the prey at a shorter distance than required with a rifle.

If a projected arrow fails to impact the prey many times it may be embedded into a tree or other object and in order to retrieve the arrow a device such as an arrow remover must be used to extract the embedded arrow. The use of a tool or device to extract an arrowhead is important and necessary, since the arrowhead normally is embedded due to the substantial momentum that the arrow is projected from the bow. Removal of arrowhead embedded in an object can be difficult if not impossible without the assistance of a tool or a removal device. Normally, the body of the arrow must be removed from the arrowhead exposing a threaded end shank of the arrowhead. A tool or removal aid may be attached to this threaded end of the arrow. The threaded end shank of the arrowhead is essentially joined to the body of the arrowhead while in use. An extractor may be placed upon the shank and then used with other components of the extraction tool to remove the arrow from the embedded object.

U.S. Pat. No. 5,408,734 discloses an arrowhead extractor for the extraction of an arrowhead from a relatively dense object in which the arrowhead is embedded by applying a steady and constant concentric tensile forced to the shank of the arrowhead. U.S. Pat. No. 5,416,963 discloses an arrowhead tip remover for removing field and target arrow tips lodged in objects which includes a rigid tubular sleeve with a tip end and a base end with the base end having an extended bore formed adapted to receive base end of an arrow tip. A rigid hexagonal nut is provided to receive a wrench and therefore provide the means to dislodge the embedded arrow tip. The foregoing demonstrates the numerous designs of arrowhead removers known within the prior art, however further development in this area is conceivable and necessary for optimum use of a removal tool.

### SUMMARY OF THE INVENTION

The present invention relates to an arrowhead removal device and a method of use thereof for removing an arrowhead comprising: a housing, wherein said housing includes a first opening with a first diameter and a second opening with a second diameter where the second diameter is smaller than the first diameter, the first opening extending along a portion of the length of the housing and abuts the second opening, where the second opening extends the remaining length of the housing. The housing also includes a plurality of equally spaced slots. The removal device further includes an attachment shaft, wherein said attachment shaft includes a threaded surface. The attachment shaft includes a first opening with a first diameter and a second opening with a second diameter where the second diameter is smaller than the first diameter, the first opening extending along a portion of the length of the shaft and abuts the second opening where the second opening extends further along the length of the shaft. The removal device includes a means to move the shaft through the first and second opening of the housing.

### BRIEF DESCRIPTION OF DRAWINGS

FIG. 1A depicts an arrowhead removal housing in accordance with the present invention.

FIG. 1B depicts a sectional view of the arrowhead removal housing of FIG. 1A.

FIG. 2A depicts a front view of the arrowhead removal housing according to one exemplary embodiment of the present invention.

FIG. 2B depicts an alternative front view of the arrowhead removal housing according to the present invention.

FIG. 3A depicts an attachment shaft according to the present invention.

FIG. 3B depicts a sectional view of the attachment shaft according to the present invention.

### DETAILED DESCRIPTION

The present invention provides an arrowhead removal device and method of use thereof wherein a housing is provided that fits securely over an attachment shaft that attaches to an end shank of an arrowhead. Openings are provided both within the housing of the arrowhead removal device and the attachment shaft to accommodate the arrowhead shank within the shaft and the attachment shaft within the housing. Once the attachment shaft is secured to the arrowhead shank, the arrowhead may be extracted by application of force via a wing nut secured around the distal end of the attachment shaft. The attachment shaft is placed within the housing wherein the distal end thereof extends outward from the housing to allow for the application and attachment of the wing nut to apply force suitable to pull the arrowhead from an embedded position.

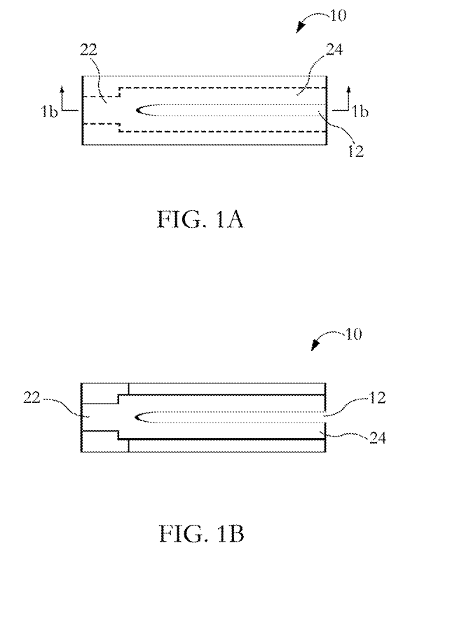

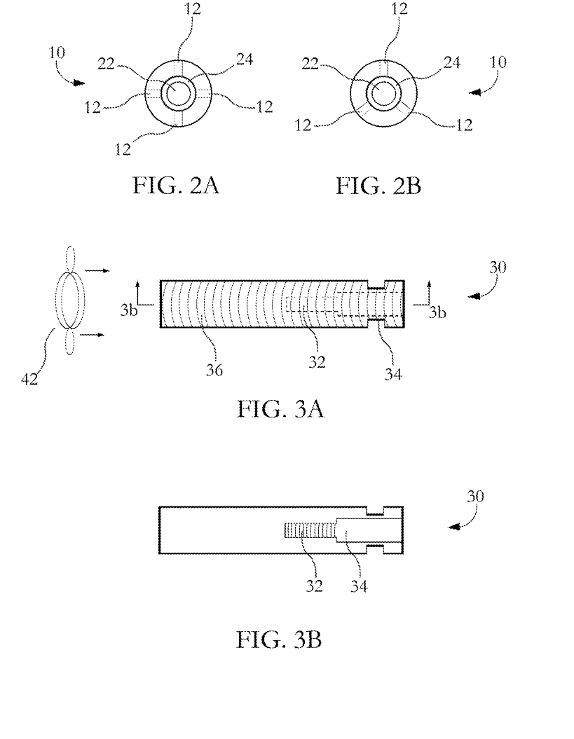

A removal housing 10 is depicted in FIG. 1A in accordance with the present invention. The removal housing 10 includes a first opening 24 that extends a portion of the length of the housing 10 and abuts the second opening 22 that extends the remainder portion of the housing 10. Also along the perimeter of the housing 10 are slots 12 that are provided for the insertion of vanes that are normally associated with the arrowhead. The first opening 24 has a first diameter that abuts the second opening 22 that has a diameter smaller than the first opening. The housing 10 inserts over an attachment shaft 30 that extends through the first opening 24 and the second opening 22 wherein the attachment shaft 30 snugly fits through the second opening 22 and extends outward from the housing 10 through the second opening 22. A sectional view of the housing 10 is provided in FIG. 1B where the openings are clearly depicted along with a slot 12. Although one slot is shown in FIGS. 1A and 1B, depending on the embodiment of the housing 3 or 4 slots may be actually used within the housing 10 which is more clearly depicted in FIGS. 2A, 2B.

A front view of the housing 10 is depicted in the 2A. This particular embodiment of the housing 10 includes four slots 12 are equally spaced along the perimeter of the housing 10. These slots 12 provide for the insertion of vanes extending from the arrowhead that may be the object of removal using the arrowhead removal device of the present invention. As noted from the front view the first diameter of the first opening 24 is seen and the smaller diameter of the second opening 22 is also noted. FIG. 2B provides an alternative embodiment of the present invention where 3 slots equally spaced on the perimeter of the arrowhead housing 10 are shown.

The three slots provide for the insertion of vanes that extend from a three-vane arrowhead for extraction thereof. Similar to the embodiment of FIG. 2A the housing 10 of FIG. 2B includes a first opening 24 and a second opening 22.

An attachment shaft 30 is used to attach to the exposed shank of an arrowhead. The attachment shaft 30 includes an opening 34 and a second opening 32 that extends along a portion of the length of the shaft 30. The shaft 30 includes a threaded outer surface 36 which may easily receive a wing nut 42 as depicted in FIG. 3A. The first opening 34 provides for the insertion of the arrowhead shank and the second opening 32 has a threaded inner surface that is clearly depicted in the sectional view of FIG. 3B. The second opening 32 firmly attaches the arrowhead shank to the shaft 30. Once the shaft 30 is firmly attached to the arrowhead, the distal end of the shaft 30 is inserted within the housing 10. Once within the housing 10, the wing nut 42 is placed upon the distal end of the attachment shaft 30. The wing nut 42 may be tightened and therefore provide vertical force to remove the embedded arrowhead.

The arrowhead removal device according to present invention allows a hunter to easily remove any embedded arrows that may be the result of missed shots during hunting. The arrowhead removal device is of sufficient size to effectively remove the arrowhead but small enough to be easily transported by the hunter. In one particular embodiment of the present invention, the housing 10 is about two and a half inches in length and the attachment shaft 30 is three inches in length. Therefore once the attachment shaft 30 is attached to the shank of object arrow the housing 10 is placed over the attachment shaft 30. The difference in length allows the attachment shaft 30 to extend from the distal end of the housing 10 through opening 22. After the housing 10 and shaft 30 are coupled, the wing nut 42 may be easily attached to the shaft 30 and tightened to apply the necessary force to remove the embedded arrowhead. The attachment shaft 30 includes a notched area 34 that provides for the attachment of an o-ring to the proximal end of the attachment shaft 30.

What is claimed is:

1. An arrowhead removal device for removing an arrowhead comprising:
a. a housing, wherein said housing includes a first opening with a first diameter and a second opening with a second diameter where the second diameter is smaller than the first diameter, the first opening extending along a portion of the length of the housing and abuts the second opening where the second opening extends the remaining length of the housing, further said housing includes a plurality of equally spaced slots;
b. an attachment shaft, wherein said attachment shaft includes a threaded surface, said shaft includes a first opening with a first diameter and a second opening with a second diameter where the second diameter is smaller than the first diameter, the first opening extending along a portion of the length of the shaft and abuts the second opening where the second opening extends further along the length of the shaft; and
c. a means to move the shaft through the first and second opening of the housing.

2. The arrowhead removal device according to claim 1, where said second opening of the attachment shaft includes a threaded surface, said threaded surface provides a means for the attachment of an arrowhead shank.

3. The arrowhead removal device according to claim 2, where said means to move the shaft through the housing is a wing nut.

4. The arrowhead removal device according to claim 1, where said plurality of slots includes three slots, where said slots provide a means for the insertion of arrowhead vanes.

5. The arrowhead removal device according to claim 1, where said plurality of slots includes four slots, where said slots provide a means for the insertion of arrowhead vanes.

6. A method of removing an embedded arrowhead comprising the steps of:
a. removing an arrow body from the arrowhead exposing the arrowhead shank;
b. placing an attachment shaft on the arrowhead shank, where said attachment shaft includes a threaded surface, said shaft includes a first opening with a first diameter and a second opening with a second diameter where the second diameter is smaller than the first diameter, the first opening extending along a portion of the length of the shaft and abuts the second opening where the second opening extends further along the length of the shaft;
c. turning the shaft to secure the shaft to the shank, where the shank includes threads on the inner surface of the second opening;
d. placing a housing over the shaft, where said shaft inserts through a first opening of the housing and a second opening of the housing, where the distal end of the shaft extends out of the housing;
e. inserting a means to move the shaft through the housing onto the distal end of the shaft; and
f. moving the shaft through the housing until the embedded arrowhead is dislodged.

7. The method according claim 4, where said means to move the shaft includes a wing nut.
